(19) United States
(12) Patent Application Publication
(10) Pub. No.: US 2020/0055429 A1
(43) Pub. Date: Feb. 20, 2020

(54) FLEXIBLE FABRIC FOR THE INTERIOR OF A VEHICLE, SEAT COVER FOR A VEHICLE SEAT, VEHICLE SEAT AND VEHICLE

(71) Applicant: ADIENT ENGINEERING AND IP GMBH, Burscheid (DE)

(72) Inventors: Tomás DRBOHLAV, Liberec (CZ); Miroslav RÍHA, Strakonice (CZ); Jaroslav LÍR, Velim (CZ)

(21) Appl. No.: 16/346,738

(22) PCT Filed: Nov. 2, 2017
(86) PCT No.: PCT/EP2017/001273

§ 371 Date: May 1, 2019

(30) Foreign Application Priority Data
Nov. 2, 2016 (DE) 10 2016 013 016.4

(51) Int. Cl. B60N 2/58; B60Q 3/233

(52) U.S. Cl. CPC B60N 2/58; B60Q 2500/10; B60Q 3/233

(57) ABSTRACT

A flexible fabric (1) for an interior of a vehicle, a seat cover having the flexible fabric (1), a vehicle seat having the seat cover, and a vehicle with such a seat are disclosed. The flexible fabric (1) is provided for a vehicle seat and has an at least partially translucent top layer (7). A lighting device (9, 10) is provided. At least partially translucent spacer layer (3) is arranged at least partially between the lighting device (9, 10) and the top layer (7). The spacer layer (3) has at least one embossed line (4, 8) in which the lighting device (9, 10) is accommodated. Backlighting is provided over a large area for such a flexible fabric in the interior of a vehicle.

### CROSS REFERENCE TO RELATED APPLICATIONS

This application is a United States National Phase Application of International Application PCT/EP2017/001273, filed Nov. 2, 2017, and claims the benefit of priority under 35 U.S.C. § 119 of German Application 10 2016 013 016.4, filed Nov. 2, 2016, the entire contents of which are incorporated herein by reference.

### TECHNICAL FIELD

The invention relates to a flexible planar formation for the interior of a vehicle, in particular for a vehicle seat, having an at least partially light-permeable cover layer, having a lighting device and having an at least partially light-permeable spacer layer, wherein the spacer layer is at least partially disposed between the lighting device and the cover layer. The invention furthermore relates to a seat cover with the flexible planar formation, a vehicle seat with the flexible planar formation and to a vehicle with the flexible planar formation.

### TECHNICAL BACKGROUND

A flexible planar formation of this type is known from the German unexamined and first publication DE 10 2015 102 407 A1. This known flexible planar formation is a flexible planar light which is in particular provided for use in an item of clothing. In the case of this planar light, the lighting means is disposed so as to be spaced apart from a reflection layer by way of a spacer layer and by way of the light-exit side of said lighting means face said reflection layer. Light emitted by the lighting means is reflected on the reflection layer and on the further way of said light to the cover layer is diffused in the spacer layer and further spacer layers. On account thereof, a uniform radiation of light from the cover layer is to be achieved. The spacer layer, after positioning the lighting means, is disposed above the lighting means and is elastically deformed when the spacer layer is impressed by the lighting means.

A planar light for a vehicle is moreover known from the German unexamined and first publication DE 10 2013 021 690 A1. This planar light has layers of plastics material and is thus not a flexible but a substantially rigid planar formation. The planar light is thus in particular not suitable as a cover material.

### SUMMARY

The invention is based on the object of providing an alternative large-area background lighting for a flexible planar formation in the interior of a vehicle, in particular for a vehicle seat. Furthermore, a seat cover for a vehicle seat, a vehicle seat, and a vehicle are to be provided.

The invention achieves this object by way of a flexible planar formation for the interior of a vehicle, in particular for a vehicle seat, having an at least partially light-permeable cover layer, having a lighting device, and having an at least partially light-permeable spacer layer which is at least partially disposed between the lighting device and the cover layer, it is provided according to the invention that the spacer layer has embossed lines in which the lighting device is received. Structures for a desired visual appearance in the flexible planar formation can be provided in a targeted manner by means of the embossed lines, and the lighting device can be disposed according to said structures.

The embossed lines are preferably provided on a side of the spacer layer that faces away from the cover layer. The lighting device furthermore radiates light preferably in the direction of the cover layer. On account thereof, a maximum spacing between the lighting device and the cover layer is achieved in the flexible planar formation in the case of a predefined thickness of the flexible planar formation.

Preferably, at least one further spacer layer, in particular exactly one further spacer layer, is disposed between the spacer layer and the cover layer. The respective spacer layer is in particular a textile layer. The respective spacer layer preferably has diffusion elements on which light passing through the spacer layer is diffused. The respective spacer layer is particularly preferably a 3D woven spacer fabric, or a 3D warp or weft knitted spacer fabric, or a 3D flat or circular knitted spacer fabric. Threads of the respective textile layer are thus diffusion elements in the spacer layer on which light is diffused or else diffracted. This overall ensures a uniform distribution of light in the region of the cover layer and thus a uniform planar appearance of lit regions of the flexible planar formation.

The flexible planar formation preferably also has a base layer, wherein the spacer layer and the lighting device are disposed between the cover layer and the base layer. Light in the spacer layer is thus fully or partially prevented from exiting the flexible planar formation on the rear side of the flexible planar formation which faces the cover layer. At least part of the light in the spacer layer is reflected on the base layer. The base layer is in particular a textile layer, in particular a fabric layer.

In the case of one advantageous embodiment of the invention, the flexible planar formation has a barrier layer which is disposed between the spacer layer and the cover layer and which has at least one clearance through which light from the spacer layer can reach the cover layer. The barrier layer thus counteracts any exiting of light through the cover layer in regions which are not assigned to the clearance. Light can exit in regions of the cover layer which are assigned to the clearance. Contours of the clearance ensure clearly delimited contours between lit and non-lit regions of the cover layer. The barrier layer provided to this end is preferably a substantially light-impermeable foil/film. The barrier layer is particularly preferably a black foil/film. The barrier layer ensures a dark background for the cover layer in regions which are not assigned to the clearance and thus increases the brightness contrast between lit and non-lit regions of the cover layer.

The clearance in the barrier layer is particularly preferably disposed so as to correspond to the lighting device and thus in particular so as to correspond to the embossed lines in the spacer layer. The spacer layer is thus illuminated only in regions from which light can also reach the cover layer through the at least one clearance of the barrier layer.

According to one embodiment of the invention, the cover layer is a textile layer. It is advantageous for the cover layer according to embodiments according to the invention to be transparent, white-colored or light-colored. Against this background, the upper side of the cover layer can be sufficiently back-lit.

The cover layer has an exposed upper side and a lower side that faces the barrier layer. The cover layer on the exposed upper side thereof is preferably printed by an ink-jet printer or by means of screen printing. Alternatively or additionally, the cover layer at least on the exposed upper side thereof has a combination of a plurality of textiles. Various visual effects can be achieved on account thereof.

Light-emitting diodes are preferably provided as the lighting device. Tapes having a plurality of light-emitting diodes which in the production of the flexible planar formation are placed into the embossed lines are in particular provided.

The layers of the flexible planar formation are fixed to one another, wherein the layers are preferably adhesively bonded to one another at adjacent area portions. On account thereof, a composite of a plurality of layers which however continues to be flexible is produced.

A seat cover according to the invention for a vehicle seat has the flexible planar formation according to the invention or a flexible planar formation which has an at least partially light-permeable cover layer, a lighting device, and an at least partially light-permeable spacer layer which is at least partially disposed between the lighting device and the cover layer. A vehicle seat according to the invention has the seat cover according to the invention. A vehicle according to the invention has the flexible planar formation according to the invention in the interior of the vehicle, or has the vehicle seat according to the invention.

Further embodiments are derived from the drawings and from the description hereunder of an exemplary embodiment illustrated in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a simplified schematic side illustration showing a flexible planar formation according to an exemplary embodiment of the invention;

FIG. 2 is a view showing a spacer layer of the flexible planar formation of FIG. 1, having embossed lines;

FIG. 3 is a view showing the spacer layer of FIG. 2 having lighting device received in the embossed lines;

FIG. 4 is a view showing a barrier layer having clearances; and

FIG. 5 is a plan view showing the flexible planar formation.

### DESCRIPTION OF PREFERRED EMBODIMENTS

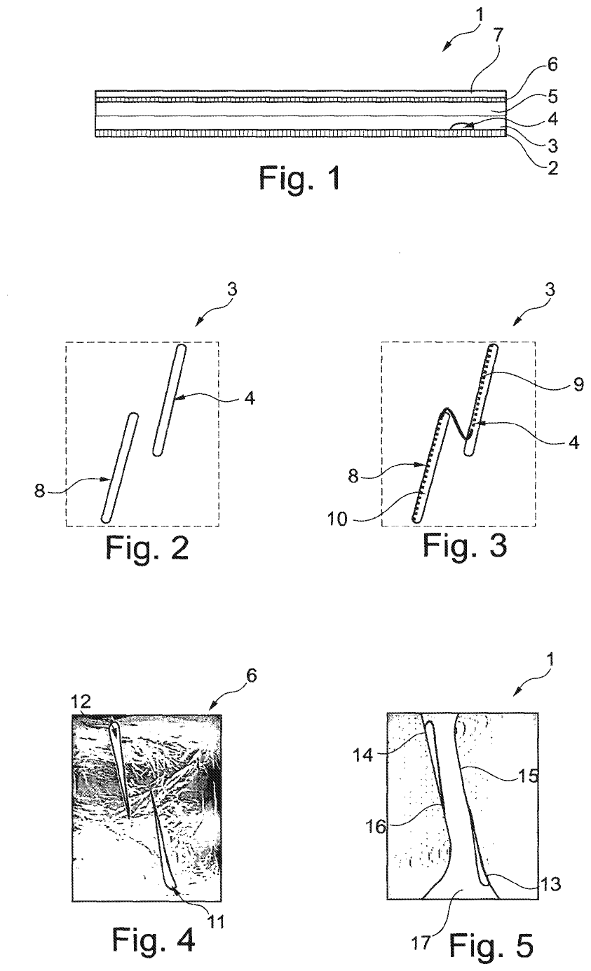

Referring to the drawings, a flexible planar formation according to the invention is schematically illustrated in a lateral sectional illustration and is provided with the reference sign 1 in FIG. 1. The flexible planar formation 1 is, for example, part of a seat cover in a vehicle, or part of a textile interior trim in an interior of the vehicle. The flexible planar formation 1, above a base layer 2 configured on the rear side, has a spacer layer 3 in the form of a 3D spacer textile. An embossed line 4 which serves for receiving a lighting device is incorporated on the side of the spacer layer 3 which faces the base layer 2. A further spacer layer 5 in the form of a spacer textile is disposed above the spacer layer 3. The further spacer layer 5 is covered with a barrier layer 6 in the form of a black foil/film. A cover layer 7 configures the upper side of the flexible planar formation 1 above the barrier layer 6. The cover layer 7 is a textile layer which is at least partially light-permeable. The spacer layers 3 and 5 are also at least partially light-permeable and serve as diffusion layers in which light is diffused. The further spacer layer 5 can optionally be omitted. Moreover, additional further spacer layers can be provided. All layers 2, 3, 5, 6, and 7 that bear in a planar manner on one another are adhesively bonded to one another.

FIG. 2 shows a plan view of the lower side of the spacer layer 3 that faces the base layer 2. The embossed line 4 and a further embossed line 8 can be seen. Electrically interconnected lighting devices 9 and 10 in the form of light-emitting diode strips having a multiplicity of light-emitting diodes are disposed in the embossed lines 4 and 8 in FIG. 3.

FIG. 4 shows a plan view of the barrier layer 6 having two clearances 11 and 12. FIG. 5 finally shows the flexible planar formation 1 in a plan view, having illumination regions 13 and 14 which are disposed above the clearances 11 and 12 and, on account thereof, are back-lit by the lighting devices 9 and 10. The illumination regions 13 and 14 are regions in the cover layer 7 which, even when not lit, at least visually and preferably also in terms of the textile surface properties thereof differ from further regions 15, 16, and 17 in the cover layer 7.

All features mentioned in the above description and in the drawing are capable of being combined with one another in any arbitrary selection. The disclosure of the invention is thus not limited to the combinations of features described, claimed, or shown in the drawing;

rather all combinations of features which are expedient in the context of the invention are to be considered as disclosed.

While specific embodiments of the invention have been shown and described in detail to illustrate the application of the principles of the invention, it will be understood that the invention may be embodied otherwise without departing from such principles.

1. A flexible planar formation for an interior of a vehicle, the flexible planar formation comprising.
an at least partially light-permeable cover layer;
a lighting device; and
an at least partially light-permeable spacer layer at least partially disposed between the lighting device and the cover layer, wherein the spacer layer has at least one embossed line in which the lighting device is received.

2. The flexible planar formation as claimed in claim 1, wherein the embossed line is provided on a side of the spacer layer that faces away from the cover layer.

3. The flexible planar formation as claimed in claim 1, further comprising at least one further spacer layer disposed between the spacer layer and the cover layer.

4. The flexible planar formation as claimed in claim 1, wherein the spacer layer is a textile layer.

5. The flexible planar formation as claimed in claim 1, wherein the spacer layer has diffusion elements on which light passing through the spacer layer is diffused.

6. The flexible planar formation as claimed in claim 1, wherein the spacer layer is a 3D woven spacer fabric, or a 3D warp or weft knitted spacer fabric, or a 3D flat or circular knitted spacer fabric.

7. The flexible planar formation as claimed in claim 1, further comprising a base layer, wherein the spacer layer and the lighting device are disposed between the cover layer and the base layer.

8. The flexible planar formation as claimed in claim 7, wherein the base layer is a fabric layer.

9. The flexible planar formation as claimed in claim 1, further comprising a barrier layer disposed between the spacer layer and the cover layer, the barrier layer having at least one clearance through which light from the spacer layer reaches the cover layer.

10. The flexible planar formation as claimed in claim 9, wherein the barrier layer comprises a substantially light-impermeable foil/film.

11. The flexible planar formation as claimed in claim 9, wherein the clearance in the barrier layer is disposed in a position so as to correspond to a position of the lighting device.

12. The flexible planar formation as claimed in claim 1, wherein the cover layer is a textile layer.

13. The flexible planar formation as claimed in claim 1, wherein the cover layer is transparent, white-colored, or light-colored.

14. The flexible planar formation as claimed in claim 1, wherein the cover layer at least on an exposed upper side thereof is printed by an ink-jet printer or by means of screen printing, and/or has a combination of a plurality of textiles.

15. The flexible planar formation as claimed in claim 1, wherein the lighting device comprises light-emitting diodes.

16. The flexible planar formation as claimed in claim 1, wherein the layers are adhesively bonded to one another at adjacent area portions.

17. A seat cover for a vehicle seat, the seat cover comprising a flexible planar formation the flexible planar formation comprising:
an at least partially light-permeable cover layer;
a lighting device; and
an at least partially light-permeable spacer layer at least partially disposed between the lighting device and the cover layer, wherein the spacer layer has at least one embossed line in which the lighting device is received.

18. A vehicle seat comprising a seat cover, the seat cover comprising a flexible planar formation, the flexible planar formation comprising:
an at least partially light-permeable cover layer;
a lighting device; and
an at least partially light-permeable spacer layer at least partially disposed between the lighting device and the cover layer, wherein the spacer layer has at least one embossed line in which the lighting device is received.

19. A vehicle comprising a flexible planar formation in an interior of the vehicle, flexible planar formation comprising:
an at least partially light-permeable cover layer;
a lighting device; and
an at least partially light-permeable spacer layer at least partially disposed between the lighting device and the cover layer, wherein the spacer layer has at least one embossed line in which the lighting device is received.
